(19) United States
(12) Patent Application Publication
(10) Pub. No.: US 2005/0206331 A1
(43) Pub. Date: Sep. 22, 2005

(54) Hybrid locomotive configuration

(75) Inventor: Frank Wegner Donnelly, North Vancouver (CA)

Correspondence Address: SHERIDAN ROSS PC, 1560 BROADWAY, SUITE 1200, DENVER, CO, 80202, US

(73) Assignee: Railpower Technologies Corp., North Vancouver (CA)

(21) Appl. No.: 11/075,550

(22) Filed: Mar. 8, 2005

Related U.S. Application Data
(60) Provisional application No. 60/551,519, filed on Mar. 8, 2004.

(51) Int. Cl. H02P 5/46

(52) U.S. Cl. 318/52

(57) ABSTRACT

The present invention is directed to a locomotive that includes:
(a) a transmission 105 operable to drive a plurality of axles;
(b) an electric motor 104 operatively connected to and driving the transmission;
(c) an energy storage unit 106 operable to store electrical energy and supply electrical energy to the electric motor;
(d) one or more prime movers 102 operable to supply electrical energy to the energy storage unit and electric motor; and
(e) a power distribution bus 109 electrically connecting the energy storage unit, prime mover(s), and electric motor. The energy storage unit and/or generator provide electrical energy to the electric motor via the power distribution bus to cause the electric motor to rotate the axles via the transmission.

### CROSS REFERENCE TO RELATED APPLICATION

The present application claims the benefits, under 35 U.S.C. § 119(e), of U.S. Provisional Application Ser. No. 60/551,519, filed Mar. 8, 2004, entitled “HYBRID LOCOMOTIVE CONFIGURATION”, which is incorporated herein by this reference.

### FIELD

The present invention relates generally to a hybrid locomotive power source and drive train configuration which is suitable a variety of applications.

### BACKGROUND

A hybrid locomotive combines a prime power unit, an energy storage system, optionally a regenerative braking system, and an axle drive system. The present inventor has disclosed the use of a battery-dominant hybrid diesel-electric locomotive in U.S. Pat. No. 6,308,639 which is incorporated herein by reference.

In North America, railroad locomotives are typically diesel-electric locomotives in which a diesel engine drives an alternator/rectifier to produce DC electric power. This power is routed via an electric transmission to electric traction motors mounted on each driving axle of a truck assembly. Such diesel-electric locomotives may be configured to provide power to either AC or DC traction motors.

In another configuration, diesel-hydraulic locomotives are often used as shunting locomotives or as road locomotives in Europe. In these locomotives, the shaft output power of a diesel engine is coupled mechanically to a hydraulic variable gear ratio transmission (also known as a hydrodynamic or turbo transmission) which, in turn, drives all the propelling axles on the locomotive typically utilizing a system of gears, drive shafts and couplings.

Thus, there remains a need for a hybrid diesel-electric locomotive power system that can be adapted to a transmission and drive system such as used on diesel-hydraulic locomotives.

### SUMMARY

These and other needs are addressed by the present invention which is directed generally to a hybrid locomotive having a hybrid power system operably engaged with a motor. The motor operates a transmission or mechanical gearbox and any one of a number of known axle drive systems to achieve a locomotive configuration with a number of unique advantages.

In one embodiment of the present invention, a hybrid power system is used to provide AC power to a single AC motor and gearbox assembly. The gearbox assembly is connected to drive axles on the locomotive using any one of a number of known axle drive systems. Power for the AC motor is supplied by means of an inverter connected to a DC power bus. The DC bus receives input power from either or both of an energy storage system and a prime power source whose mechanical power output is converted to electrical power by an alternator/rectifier apparatus.

In another embodiment of the present invention, a hybrid power system is used to provide DC power to a single DC motor and gearbox assembly. The gearbox assembly is connected to the drive axles on the locomotive using any one of a number of known axle drive systems. Power for the DC traction motor is supplied by means of a chopper circuit connected to a DC bus. The DC bus receives input power from either or both of an energy storage system and a prime power source whose mechanical power output is converted to electrical power by an alternator/rectifier apparatus.

In another aspect of the invention, the DC electrical energy from the alternator/rectifier apparatus may also drive one or more additional inverters to supply the auxiliary power requirements of the locomotive and any attached cars.

In another aspect of the invention, a dynamic braking system may be employed to augment the main braking system. In addition, the dynamic braking system may include a regenerative braking system to recover kinetic energy dissipated during braking and return it to the energy storage system.

In yet another embodiment, the prime energy source of a hybrid locomotive may be augmented from time to time by an external source such as an overhead electrical catenary or a third electrified rail.

The above invention can provide a number of unique advantages over the prior art. The invention can allow a hybrid power supply to be used with axle driving systems typical of conventional diesel-hydraulic locomotives. This allows the locomotive to run on batteries alone when necessary for emission free operation. The invention can also allow the locomotive to run with minimal engine usage when necessary for low emissions operation. The invention can allow the locomotive to be capable of high accelerations when necessary by providing propulsive power simultaneously from both the prime power source and energy storage unit. The invention can allow the locomotive to capture kinetic energy from braking by a regenerative braking system connected to the energy storage system. The invention can also permit a wide range of combinations of prime power and energy storage which make the invention suitable for switcher locomotives, commuter locomotives, various industrial locomotives and as B-unit locomotives in locomotive consists.

These and other advantages will be apparent from the disclosure of the invention(s) contained herein.

As used herein, “at least one . . . and”, “at least one . . . or”, “one or more of . . . and”, “one or more of . . . or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, and A, B and C together.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 shows a typical arrangement of the principal components of a hybrid locomotive.

FIG. 2 illustrates the functional relationships of the principal components of a hybrid locomotive.

FIG. 3 shows a typical arrangement of the principal components of a hybrid locomotive with regenerative braking.

FIG. 4 illustrates the functional relationships of the principal components of a hybrid locomotive with regenerative braking.

FIG. 5 is a representation of the DC bus that connects a hybrid power system with a motor that can power a mechanical drive system.

### DETAILED DESCRIPTION

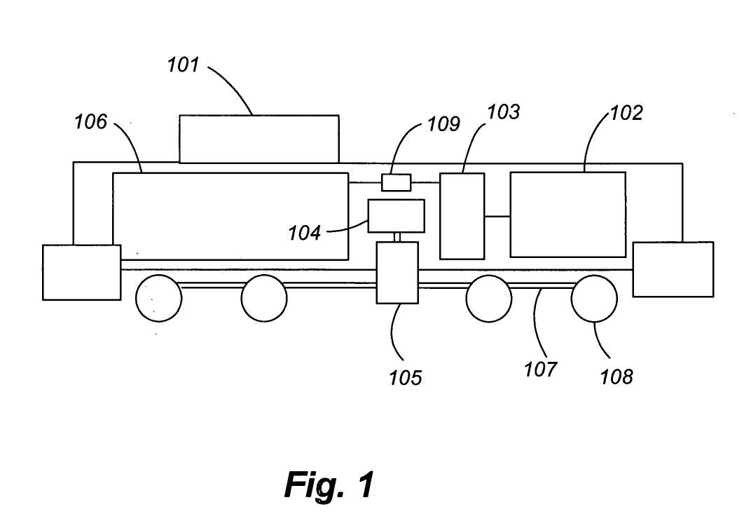

FIG. 1 shows a typical arrangement of the principal components of a hybrid locomotive representing an embodiment of the present invention. This example shows a locomotive with four sets of driving wheels 108 and an operator's cab 101. Prime power is provided by one or more prime movers 102. Examples of such prime movers include diesel engines, gas turbine engines, microturbines, Stirling engines, spark ignition engines and fuel cells. The engines 102 are used to drive a power conversion unit 103 which provides DC electrical power to a DC bus 109. The power conversion unit 103 may be an alternator/rectifier, for example. In the case of a prime mover such as fuel cells, the power conversion unit 103 may be a simple chopper or a more versatile buck/boost circuit. An energy storage unit 106 is also connected to the DC bus 109. The energy storage system may be, for example, a battery pack, a bank of capacitors, a compressed air storage system with an air motor or turbine, or a flywheel of which a homopolar generator is an example, or a combination of these. Power from the DC bus 109 can flow to or from the energy storage unit 106, or to a second motor 104. As can be appreciated, the DC bus can provide power to the second motor 104 simultaneously from both the prime movers 102 and the energy storage unit 106. Because of blocking diodes in the power conversion unit 103, power can never flow back to the engines 102. The DC bus may also transmit electrical power to an auxiliary power supply (not shown) such as might be used to operate the locomotive's lighting and braking system for example. The motor 104 may be, for example, an AC induction motor, DC motor, permanent magnet motor or switched reluctance motor. If the motor 104 is an AC motor, it receives AC power by means of an inverter (not shown) connected to the DC bus 109. Alternately, if the motor 104 is a DC motor, it receives DC power using for example a chopper circuit (not shown) connected to the DC bus.

The engines 102 are large enough to provide a significant portion of the output power of the locomotive and therefore requires a fuel tank (not shown). The fuel tank can be located inside the locomotive or carried underneath as a belly tank or can be both. The power rating of the engines 102 is preferably in the range of 100 to 2,500 kW. The storage capacity of the energy storage unit 106 is preferably in the range of 500 to 2,500 kW-hrs.

The output shaft of the motor 104 is mechanically connected to a transmission or gear box 105. The gear box 105 may be reducing or increasing gears and may be single- or double-reducing or increasing gears. The gear mechanisms may be provided by helical gears and pinions, gear belts, chain and sprocket arrangements or any number of other well known gear box mechanisms. The gear box 105 rotates a drive shaft 107 which dives the axles and wheels 108. The axle drive mechanism can be any one of a number of known axle drive systems such as for example drive systems comprised of drive shafts, cardan shafts, universal joints, bevel gears, spur bevel gears, spur gears and the like. Examples of other drive systems include drive shafts and limited slip or self-locking differential systems. The locomotive configuration may be controlled from an operator's cab 101 or it may be a remotely controlled locomotive.

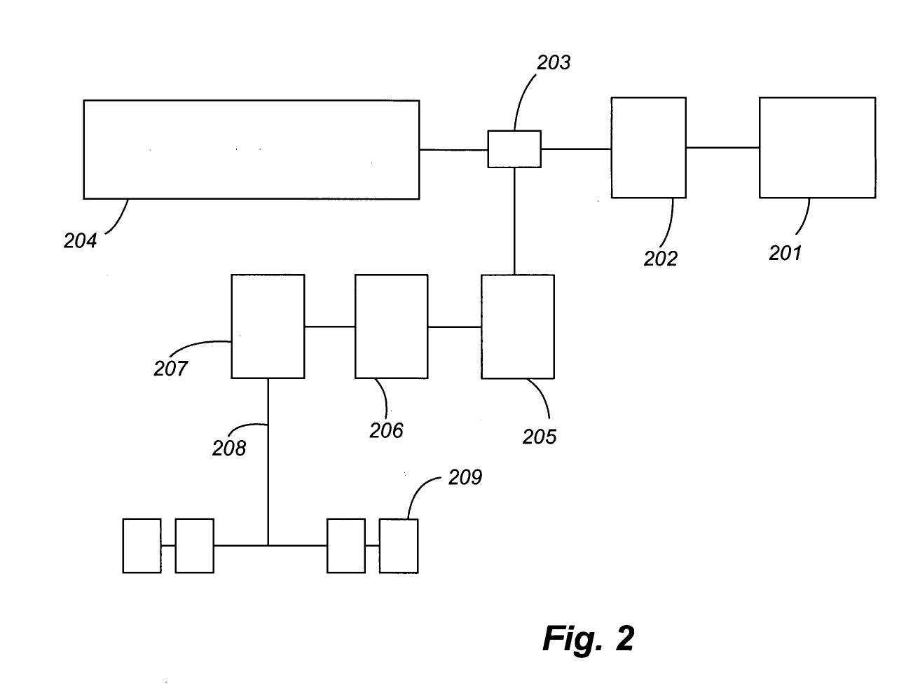

FIG. 2 illustrates further the functional relationships of the principal components a hybrid locomotive such as described in FIG. 1. Prime power is provided by one or more prime movers 201. The engines 201 are connected through a power conversion unit 202 to a DC power distribution bus 203. Energy storage is provided by one or more energy storage units 204. The energy storage units 204 are also connected to the DC bus 203. The DC bus 203 feeds DC power to an inverter 205 which provides AC power to an AC motor 206. An alternate configuration is a DC bus 203 that feeds DC power to a chopper circuit 205 which provides DC power to a DC motor 206. The output of the motor 206 is mechanical shaft power connected to a gear box 207. The gear box 207 rotates a drive shaft 208 which drives the axles and wheels 209.

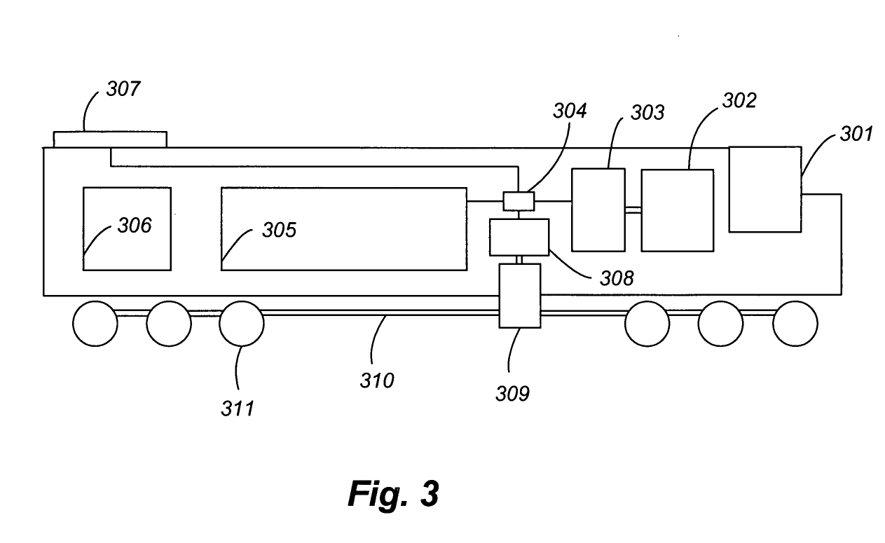

FIG. 3 shows a typical arrangement of the principal components for a hybrid locomotive with regenerative braking. Prime power is provided by one or more prime movers 302. Examples of prime movers were given previously in the description of FIG. 1. Prime power is sent to a DC power distribution bus 304 through a power conversion unit 303. Examples of power conversion systems were given previously in the description of FIG. 1. Energy storage is provided by one or more energy storage units 305 which are also connected to the DC bus 304. Examples of energy storage devices were given previously in the description of FIG. 1. The wheels 311 of the locomotive are driven by a drive shaft 310 which in turn is driven by a gearbox 308. The gearbox 309 is powered by a traction motor 308. Examples of motors were given previously in the description of FIG. 1. The motor 308 receives it electrical input power from the DC bus 304 which, in turn, receives power from either or both of the energy storage unit 305 and power conversion apparatus 303. Fuel for the engines 302 is obtained from a fuel tank 306. This embodiment includes a dynamic and regenerative braking system. During braking, the motor 308 can be switched to function as an electrical generator to convert kinetic energy of braking to electric energy which is then transferred via the DC bus 304 for storage in the energy storage unit 305. Any excess energy that cannot be stored in the energy storage unit 305 is transferred to resistance grids 307 to be dissipated. In this embodiment, the energy storage unit 305 is recharged as required either by the engines 303 or by the regenerative braking system. The power rating of the generator 302 is preferably in the range of 500 to 2,500 kW. The storage capacity of the energy storage unit 106 is preferably in the range of 500 to 2,500 kW-hrs. The capacity of the fuel tank 306 is preferably in the range of 500 to 6,000 gallons. The locomotive may be controlled from an operator's cab 301 or it may be a remotely controlled locomotive.

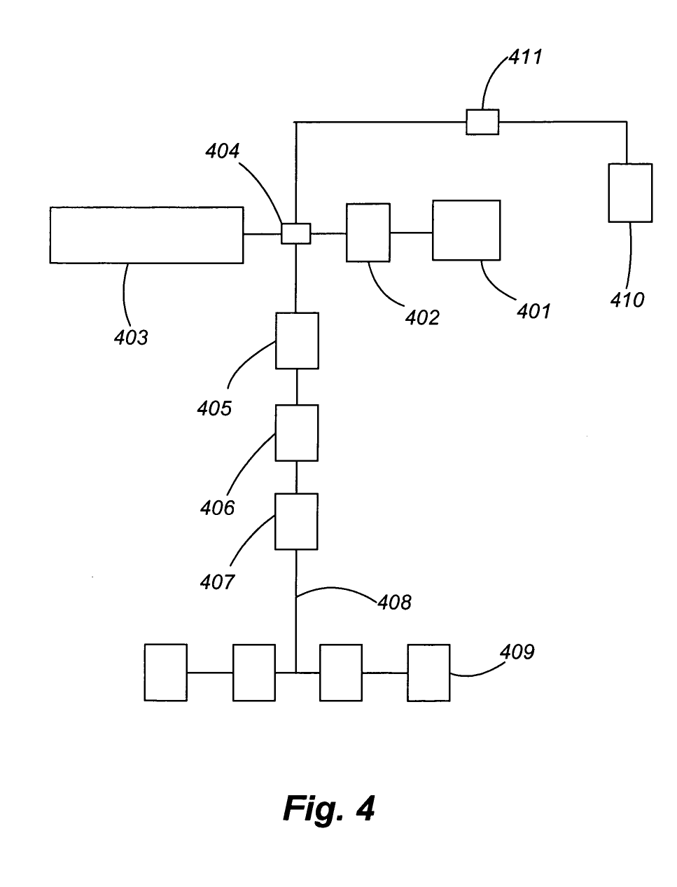

FIG. 4 illustrates the functional relationships of the principal components a hybrid locomotive with regenerative braking. Prime power is provided by prime movers (engines) 401 which is converted to DC electrical energy through a first power conversion unit 402 such as, for example an alternator/rectifier connected to a DC power distribution bus 404. An energy storage system 403 is also connected to the DC bus 404. During motoring, the DC bus feeds DC power to a motor 406 through a second power conversion apparatus 405. If the motor 406 is an AC motor, the second power conversion apparatus 405 is an inverter. Alternately, if the motor 406 is a DC motor, the second power conversion apparatus 405 is a chopper circuit. When in braking mode, the motor 406, now acting as a generator, returns power to the DC bus 404. Because of blocking diodes in the power conversion unit 402, power cannot flow back to the engines 401. Power can flow back to the energy storage unit 403. When a controller determines that the state-of-charge of the energy storage unit 403 reaches a predetermined upper limit, the excess energy from dynamic braking is transferred, by opening switch 411, to resistance grids 410 to be dissipated. The motor 406 is mechanically connected to a gear box 407. The gear box 407 rotates a drive shaft 408 which drives the axles and wheels 409.

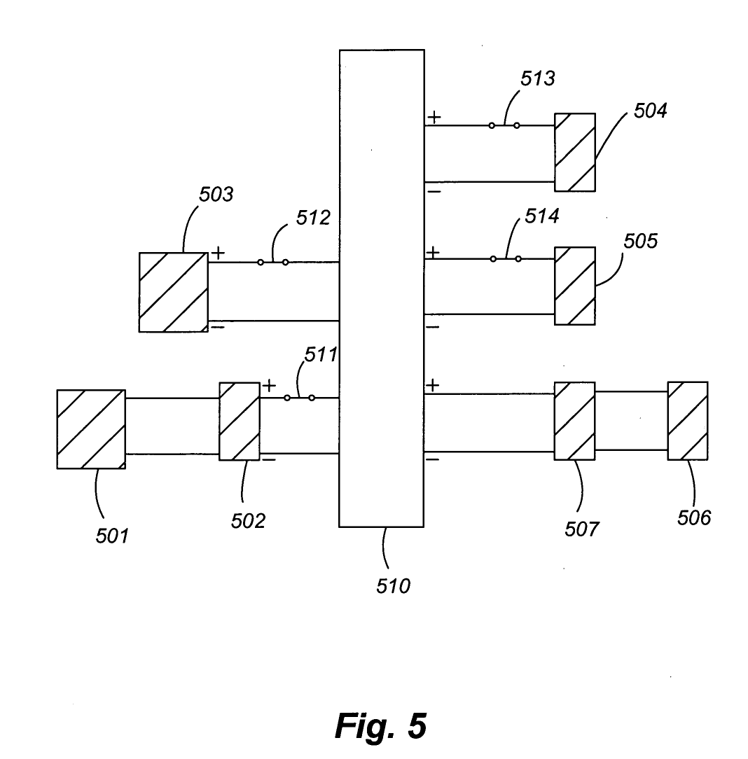

FIG. 5 is a representation of the DC bus that connects a hybrid power system with a motor that can power a mechanical drive system illustrating the connections between the major electrical components. The power supply elements consist of a prime power source 501 and power conversion apparatus 502 which converts output of the prime power source 501 to a DC electrical power connected to an electrical distribution bus 510. An electrical energy storage unit 503 is electrically connected to the DC the bus 510. As shown the output of the conversion apparatus 502 and the output of the energy storage unit 503 can be switched on or off by switches 511 and 512 respectively if necessary for emergencies, maintenance or any other situation where either is not required. As can be seen, power can be supplied by the prime power source or the energy storage unit or both, depending on the relative voltage output levels of the conversion apparatus 502 and the energy storage apparatus 503. During motoring mode of the locomotive, power flows from one or both of the prime power and the energy storage units to the DC bus 510 where it supplies power to a motor 506 through a second power conversion apparatus 507. As has been described previously in the various embodiments of the present invention, the motor 506 can be an AC or DC motor and the second power conversion apparatus 507 can be an inverter (AC motor) or a chopper (DC motor). During braking mode of the locomotive, the motor 506, now acting as generator, can reverse the flow of power to supply power to the DC bus 510 which can then provide recharging energy to energy storage unit 503. As is well known, the conversion apparatus 502 typically contains circuitry to prevent power flow back to the prime power source 501 during braking mode. In addition, a resistance grid 505 is shown connected to the DC bus 510. If, during braking mode of the locomotive, there is an excess of regenerative energy from motor 506, this excess can be diverted from the energy storage unit and dissipated in the resistance grid 505 for example, by closing switch 514 and opening switch 512. An auxiliary motor 504 can also be powered from the DC bus 510 and turned on or off by switch 513. If the auxiliary motor 504 is an AC motor, it may be connected to the DC bus 510 by an inverter (not shown). As can be appreciated, any number of auxiliary power supplies can be connected to the DC bus in this way.

A number of variations and modifications of the invention can be used. As will be appreciated, it would be possible to provide for some features of the invention without providing others. For example in one alternative embodiment, the various inventive features are applied to vehicles other than locomotives, such as cars, railroad cars, and trucks. The control logic set forth above may be implemented as a logic circuit, software, or as a combination of the two.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A locomotive, comprising:
a transmission operable to drive a plurality of axles, each axle being connected to at least one wheel;
an electric motor operatively connected to and driving the transmission;
an energy storage unit operable to store electrical energy and supply electrical energy to the electric motor;
one or more prime movers operable to supply electrical energy to the energy storage unit and electric motor; and
a power distribution bus electrically connecting the energy storage unit, one or more prime movers, and electric motor, whereby the energy storage unit and/or generator provide electrical energy to the electric motor via the power distribution bus to cause the electric motor to rotate the axles via the transmission.

2. The locomotive of claim 1, further comprising:
a power conversion unit positioned between the one or more prime movers and power distribution bus and electrically connected to the bus, the power conversion unit being operable to convert the energy provided by the one or more prime movers into a form acceptable to the storage unit and electric motor.

3. The locomotive of claim 2, wherein the power conversion unit is at least one of an alternator/rectifier and a Direct Current-to-Direct Current or DC-to-DC power conditioning apparatus.

4. The locomotive of claim 1, wherein the energy storage unit is at least one of a battery pack, a bank of capacitors, a compressed air storage system, and a flywheel.

5. The locomotive of claim 1, wherein each of the storage unit and one or more prime movers provide Direct Current (DC) power to the bus and further comprising:
an inverter electrically connected to the bus and operable to convert the DC power to Alternating Current (AC) power and thereby provide modulated AC power to the electric motor, the electric motor being an AC motor.

6. The locomotive of claim 1, wherein each of the storage unit and prime mover(s) provide Direct Current (DC) power to the bus further comprising:
a chopper circuit electrically connected to the bus and positioned between the electric motor and the bus, the chopper circuit modulating power pulses provided to the electric motor, the electric motor being an DC motor.

7. The locomotive of claim 1, wherein at least one of a catenary and third rail provide Direct Current (DC) power to the bus.

8. The locomotive of claim 1, wherein a dynamic braking system and a regenerative braking system provide Direct Current (DC) power to the bus during braking.

9. A method, comprising:
providing a locomotive including a transmission driving a plurality of axles, an electric motor driving the transmission, an energy storage unit storing and supplying electrical energy to the electric motor, one or more prime movers supplying electrical energy to the energy storage unit and electric motor, and a power distribution bus electrically connecting the energy storage unit, one or more prime movers, and electric motor;
at least one of the energy storage unit and one or more prime movers providing electrical energy to the power distribution bus;
the electric motor receiving from the bus the provided electrical energy;
the electric motor driving the transmission; and
in response, the transmission rotating the axles to displace the locomotive.

10. The method of claim 9, further comprising:
a power conversion unit converting the electrical energy provided by the one or more prime movers into a form acceptable to the storage unit and electric motor.

11. The method of claim 10, wherein the power conversion unit is at least one of an alternator/rectifier and a DC to DC power conditioning apparatus and wherein the energy storage unit is at least one of a battery pack, a bank of capacitors, a compressed air storage system, and a flywheel.

12. The method of claim 9, wherein each of the storage unit and one or more prime movers provide Direct Current (DC) power to the bus and further comprising:
an inverter converting the DC power to Alternating Current (AC) power, wherein the electrical energy supplied to the electric motor is modulated AC power, and wherein the electric motor is an AC motor.

13. The method of claim 9, wherein each of the storage unit and one or more prime movers provide Direct Current (DC) power to the bus and further comprising:
a chopper circuit modulating power pulses provided to the electric motor, the electric motor being an DC motor.

14. A locomotive, comprising:
transmission means for driving a plurality of axles;
electric motor means for driving the transmission means;
energy storage means for storing and supplying electrical energy to the electric motor means;
prime mover means supplying electrical energy to the energy storage means and electric motor means; and
power distribution means electrically connecting the energy storage means, prime mover means, and electric motor means.

15. The locomotive of claim 14, further comprising:
power conversion means for converting the electrical energy provided by the prime mover means into a form acceptable to the storage means and electric motor means.

16. The locomotive of claim 15, wherein the power conversion means is at least one of an alternator/rectifier and a DC to DC power conditioning apparatus and wherein the energy storage means is at least one of a battery pack, a bank of capacitors, a compressed air storage system, and a flywheel.

17. The locomotive of claim 14, wherein each of the storage means and prime mover means provide Direct Current (DC) power to the distribution means and further comprising:
inverter means for converting the DC power to Alternating Current (AC) power, wherein the electrical energy supplied to the electric motor means is AC power, and wherein the electric motor means is an AC motor.

18. The locomotive of claim 14, wherein each of the storage means and prime mover means provide Direct Current (DC) power to the power distribution means and further comprising:
chopper circuit means for modulating power pulses provided to the electric motor means, the electric motor means being a DC motor.
